(19) United States
(12) Patent Application Publication
(10) Pub. No.: US 2014/0058535 A1
(43) Pub. Date: Feb. 27, 2014

(54) APPARATUS AND METHOD FOR CREATING AND INTEGRATING CONTROL LOGIC

(71) Applicant: GE INTELLIGENT PLATFORMS, INC., Charlottesville, VA (US)

(72) Inventor: Kenneth DICKIE, Edmonton (CA)

(73) Assignee: GE INTELLIGENT PLATFORMS, INC., Charlottesville, VA (US)

(21) Appl. No.: 13/760,204

(22) Filed: Feb. 6, 2013

Related U.S. Application Data
(60) Provisional application No. 61/691,293, filed on Aug. 21, 2012.

(51) Int. Cl. G05B 11/01

(52) U.S. Cl. CPC G05B 11/01
USPC 700/11

(57) ABSTRACT

An automation controller is selected on which to deploy control logic. At the communication network, the control logic is built for deployment to the automation controller selected. At the communication network, the control logic is mapped to the hardware configuration of the automation controller selected. The control logic is loaded on to the automation controller that is selected and the control logic is integrated to the selected automation controller.

### CROSS REFERENCES TO RELATED APPLICATIONS

This application claims benefit under 35 U.S.C. §119 (e) to U.S. Provisional Application No. 61/691,293 entitled “Solution Configurator in a Cloud-based System” filed Aug. 21, 2012, the content of which is incorporated herein by reference in its entirety.

Utility application entitled “Apparatus and Method for the Deployment and Monitoring of Control Logic” naming as inventor Kenneth Dickie and having attorney docket number 262588 (102673); and

Utility application entitled “Apparatus and Method for Providing Secure Communications in a Network” naming as inventors Gregory Dunn and Kenneth Dickie and having attorney docket number 262803 (102674), both of which are being filed on the same day as the present application and the contents of both of which are incorporated herein by reference in their entireties.

### BACKGROUND OF THE INVENTION

1. Field of the Invention

The subject matter disclosed herein relates to the creation and integration of control logic.

2. Brief Description of the Related Art

Automated devices perform various functions and these devices typically include a controller or control device that controls or manages the execution of these functions. For example, robotic controllers (e.g., those that utilize microprocessors) often control the functions of a robot and the robot can perform various manufacturing tasks. Assembly line controllers are used to control the various functions performed on or at an assembly line. A consumer device controller may be used to control the operation and functioning of any type of consumer device (e.g., security system, lighting system, heating system, traffic light or pump control). Together, these types of controllers provide automated functions and are generally referred to as automation controllers.

An automation controller typically includes and utilizes control logic to perform its functions. Control logic solutions may include computer software and/or computer hardware that performs various predetermined functions. For example, an assembly line controller (e.g., for a bottling plant) may include a microprocessor that operates programmed computer software to regulate the speed and other functions associated with operating an assembly line that fills and caps the bottles. In another example, a controller may also include a microprocessor running programmed computer software that regulates various device parameters (e.g., temperature, pressure, or operating speed). In yet another example, a water system controller may include control logic that controls pumps and sprinklers.

In conventional approaches, if a user wanted a specific control solution (e.g., control logic) they would have to develop the control logic as an entire system, purchase it from a supplier and could not collaborate with other users. This creates inefficiencies and frustration with these previous approaches.

### BRIEF DESCRIPTION OF THE INVENTION

Approaches are provided that allow customers to develop control logic, create libraries of control logic, collaborate in the development of control logic, and build control logic at a communication network. The execution and deployment of control logic on control devices is also provided.

In many of these embodiments, an automation controller is selected on which to deploy control logic. At the communication network, the control logic is built for deployment to the automation controller that is selected. At the communication network, the control logic is also mapped to the hardware configuration of the automation controller selected. The control logic is loaded onto the automation controller that is selected and the control logic is integrated to the selected automation controller.

In some aspects, building the control logic utilizes at least one control logic module stored in a data storage device. In other aspects, building the control logic utilizes at least one control logic module created by a user at the communication network. In other examples, at least one control logic module that is created by the user is stored at the data storage device.

In other examples, building the control logic uses at least one control logic module that is stored at a data storage device and additionally uses at least one control logic module created by a user at the communication network. The control logic module created by the user is stored at the data storage device in some aspects. In some aspects, the mapping is between physical devices. In other aspects, the mapping comprises a mapping between control devices and generating communication protocols between the devices such that large, complex control solutions can be created from modular components.

In others of these embodiments, an apparatus for creating control logic at a communication network and integrating the control logic to a remotely located automation controller includes an interface and a controller. The interface has an input and an output, and is configured to receive a selection from a user at the input of an automation controller on which to deploy the control logic.

The controller is deployed at a communication network and coupled to the interface. The controller is configured to build the control logic for deployment to the automation controller selected and to map the control logic to the hardware configuration of the automation controller selected. The controller is also configured to load the control logic on the automation controller that is selected.

### BRIEF DESCRIPTION OF THE DRAWINGS

For a more complete understanding of the disclosure, reference should be made to the following detailed description and accompanying drawings wherein:

FIG. 1 comprises a block diagram of a system for building and deploying control logic according to various embodiments of the present invention;

FIG. 2 comprises a flowchart of an approach for building and deploying control logic according to various embodiments of the present invention;

FIG. 3 comprises a block diagram of an apparatus for building and deploying control logic according to various embodiments of the present invention;

FIG. 4 shows a screen shot of different control logic solutions that can be purchased by a user according to various embodiments of the present invention;

FIG. 5 shows a geographical display showing a geographical layout of a plant with various pieces of control logic according to various embodiments of the present invention;

FIG. 6 shows a screen shot of a logical view of one element of control logic and interconnections of that control logic according to various embodiments of the present invention;

FIG. 7 shows a screen shot of an expansion of the “my network 2” of FIG. 6 according to various embodiments of the present invention;

FIG. 8 shows a screen shot of the mapping process according to various embodiments of the present invention;

FIG. 9 shows a block diagram showing an approach to variable mapping according to embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

In the approaches described herein, customers develop control logic, create libraries of control logic, collaborate on the development of control logic and build control solutions in a cloud-based environment. The execution and deployment of control logic on control devices is also provided. In so doing, system efficiency, cost effectiveness, and user satisfaction are improved compared to conventional approaches.

The present approaches allow customers to assemble individual pieces of control logic and create a customized control solution. By defining stand-alone classes of control logic, users can determine device inputs/outputs at the time of logic creation or at the time of deployment (e.g., provide a late binding). Users have the ability to visualize their control solutions using the different views on graphical user interfaces. For example, geo-physical views, logical views, and network views showing the control logic and/or its operation can be displayed. End users no longer need to understand the specifics of control logic code or hardware design. Instead, users can utilize pre-made or predefined logic blocks to build control logic solutions. The present approaches allow users to share libraries of control logic to facilitate rapid solution development. The present approaches also allow users to collaborate on solution development by developing components separately and integrating them at time of deployment instead of at time of development.

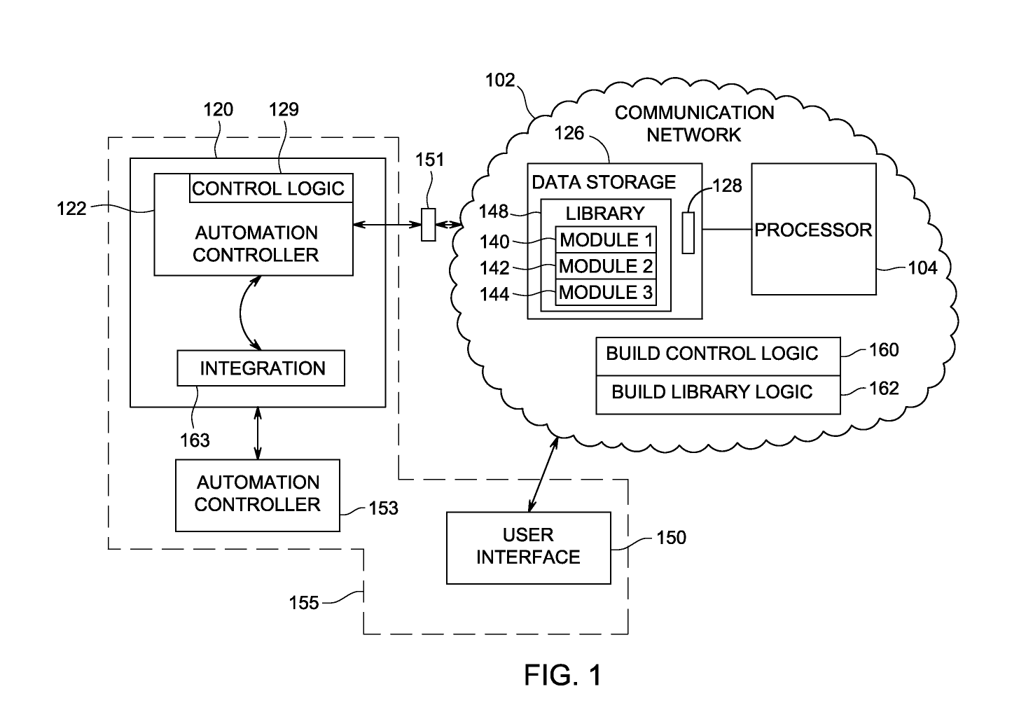

Referring now to FIG. 1, one example of a system for deploying and monitoring control logic is described. The system includes a communication network 102. The communication network 102 is coupled to a customer site 120. The customer site 120 includes an automation controller 122. The customer site may be any factory, office, home, power plant, device, communication facility (e.g., a base station) or any other location that may advantageously use an automation controller. The automation controller 122 is also in a private network 155. The private network 155 also includes a second automation controller 153. The automation controller 122 is coupled to the automation controller 155. Communications with the network 102 occur via a gateway 151. The gateway 151 provides communication and security functions as known in the art. The second automation controller 153 is shown at a different site, but it will be understood that both can be located at the same site 120.

The communication network 102 is any type of communication network such as the Internet, a computer network, a cellular telephone network, or any combination of these or other networks. In this respect, the communication network 102 may include any number of devices such as computers, access points, routers, and servers, to mention a few examples.

The communication network 102 includes a processor 104 and a data storage device (memory) 126. The data storage device 126 (which can be any type of memory device or combination of memory devices) includes a control logic representation 128.

The control logic representation 128 is a description (in one example, implemented as programmed software or code) that represents the control logic at the automation controller 122 or 153. More specifically, the control logic representation 128 describes the functions, workings, operation, inputs, outputs, and other characteristics of the operation of the associated control logic of the automation controller 122 or 153. In other aspects, the control logic representation 128 may be hardware, software, or combinations of hardware and software elements. In one aspect, the control logic representation 128 is the same as the control logic at the automation controller 122 or 153. Consequently, changes can be made to the control logic representation 128 (without halting the operation of the automation controller 122) and these can be later downloaded to the automation controller 122 or 153 and stored as control logic 129 at the automation controller 122 or 153.

The automation controller 122 or 153 may be any device, combination of devices, or network of devices that are implemented in any combination of hardware or software. In one example, the automation controller 122 or 153 is an assembly line controller. In other examples, the automation controller 122 or 153 is a controller for a pumping network (e.g., pumps, valves, pipes, sprinklers, and their associated controllers). Other examples of automation controllers and systems that utilize automation controllers are possible.

The memory also includes a first control logic module 140, a second control logic module 142, and a third control logic module 144. The modules 140, 142, and 144 are individual pieces of control logic that can be assembled as needed or desired in any combination to form control logic representation 128. Together, the modules 140, 142, and 144 are included to form a library 146.

The network 102 also includes a build control logic module 160 and a build library logic module 162. The build control logic module 160 is any combination of software and/or hardware that allows a user to build control logic. For example, the user may graphically select (using a GUI) different ones of the modules 140, 142, and 144 for assembly into a control logic representation 128. Additionally, a mapping between hardware and software components may also occur. The build library logic module 162 is any combination of software and/or hardware that allows a user to design, build, and store control logic library modules (routines) in the library 146. For instance, a user may directly enter control logic code into a GUI. The control logic may be entered according to any appropriate programming language. In another example, a user may purchase control logic and upload it into the library 146. Documentation files may also be provided to guide users in using the system or the control logic.

A graphical user interface (GUI) 150 is coupled to communication network 102 and specifically to the processor 104. In this example, GUI 150 is disposed in the private network 155. Alternatively, there may be some GUIs inside the private network 155 and some outside, or all outside. GUI 150 provides graphical screens that allow a user to build control logic and deploy the control logic to automation controllers. Physical integration 163 may occur at the automation controller. For example, during physical integration 163 a user or technician may physically connect hardware components at the automation controller 122 or 153. A dashboard may be provided on the GUI showing selected functions of control logic.

In one example of the operation of the system of FIG. 1, the automation controller 122 or 153 is selected on which to deploy control logic. At the communication network 102, the control logic representation 128 is built for deployment to the automation controller 122 or 153. At the communication network 102, the control logic is mapped to the hardware configuration of the automation controller 122 or 153. The control logic 128 is loaded on to the automation controller (as control logic 129) and the control logic and integration 163 is performed to the selected automation controller 122. The building, mapping, and deployment may be accomplished by a user at the GUI 150.

In some aspects, building the control logic utilizes at least one control logic module 140, 142, or 144 stored in a data storage device 126. In other aspects, building the control logic utilizes at least one control logic module 140, 142, or 144 created by a user at the communication network 102.

In other examples, at least one control logic module 140, 142, or 144 that is created by the user is stored at the data storage device 126. In other examples, building the control logic uses at least one control logic module 140, 142, or 144 that is stored at a data storage device 126 and also uses at least one control logic module created by a user at the communication network 102. The at least one control logic module created by the user is stored at the data storage device 126.

In the example shown, multiple automation controllers 122 and 153 communicate with each other within a private network 155. Data may flow in either direction between these devices. Other automation controllers can be added to the network 155. In this way, the approaches herein are able to create a large complex of control solutions with modular components.

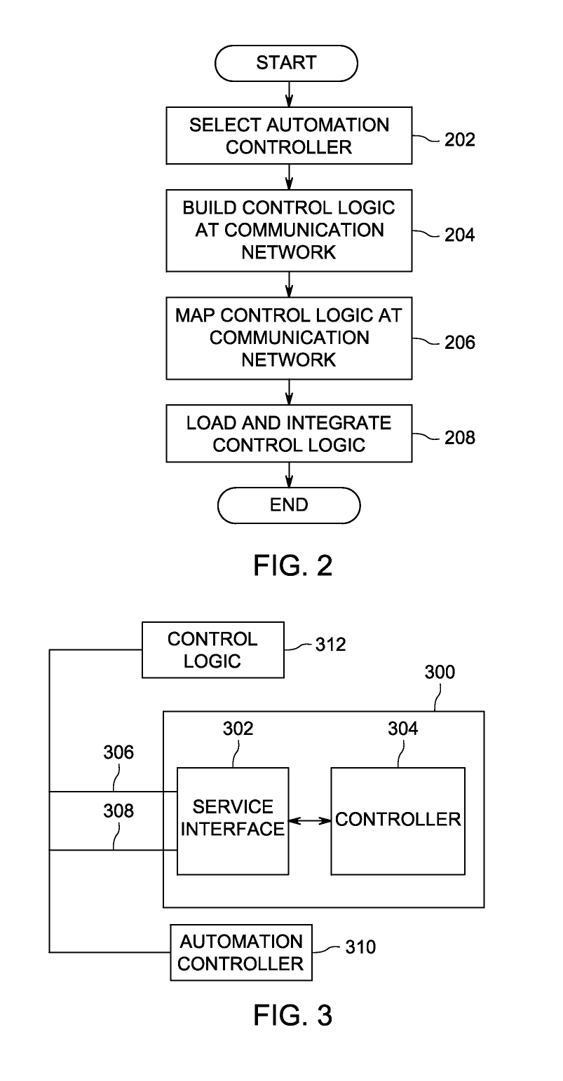

Referring now to FIG. 2, one example of an approach for building and deploying control logic is described. At step 202, an automation controller is optionally selected on which to deploy control logic. This can be accomplished by a user using a GUI. At step 204 and at the communication network, the control logic is built for deployment to the automation controller that has been selected. For instance, a user may use a GUI to drag and drop library modules on the GUI to build the control logic solution.

At step 206 and at the communication network, the control logic is mapped to the hardware configuration of the automation controller selected. At step 208, the control logic is loaded on to the automation controller that is selected and the control logic is integrated to the selected automation controller.

Referring now to FIG. 3, an apparatus 300 for building and deploying control logic is described. The apparatus 300 includes a service interface 302 and a controller 304. The interface 302 has an input 306 and an output 308 and is configured to receive a selection from a user at the input of an automation controller 310 on which to deploy control logic 312.

The controller 304 is deployed at a communication network and coupled to the interface 302. The controller 304 is configured to build the control logic 312 for deployment to the automation controller 310 selected and to map the control logic to the hardware configuration of the automation controller selected. The controller 304 is also configured to load the control logic 312 on the automation controller that is selected. Mapping is also provided between various automation controllers.

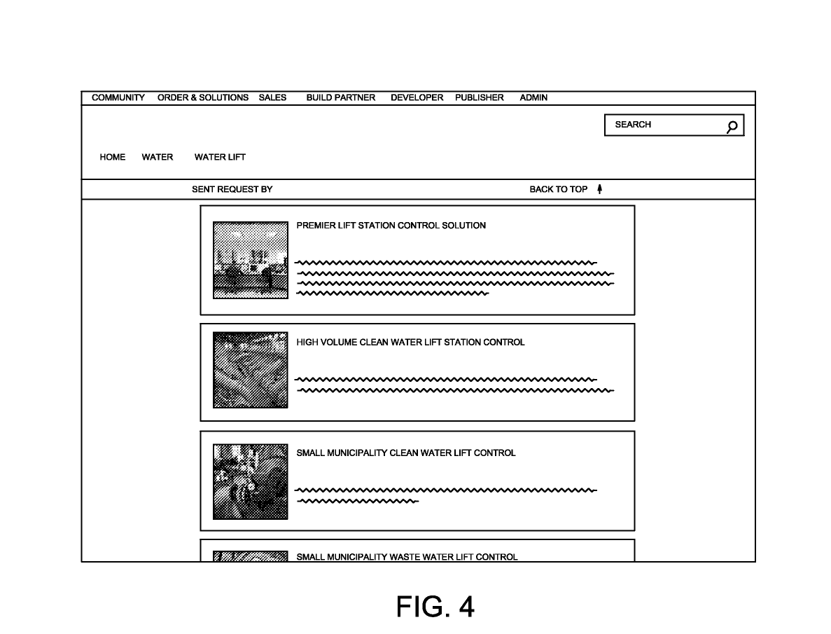

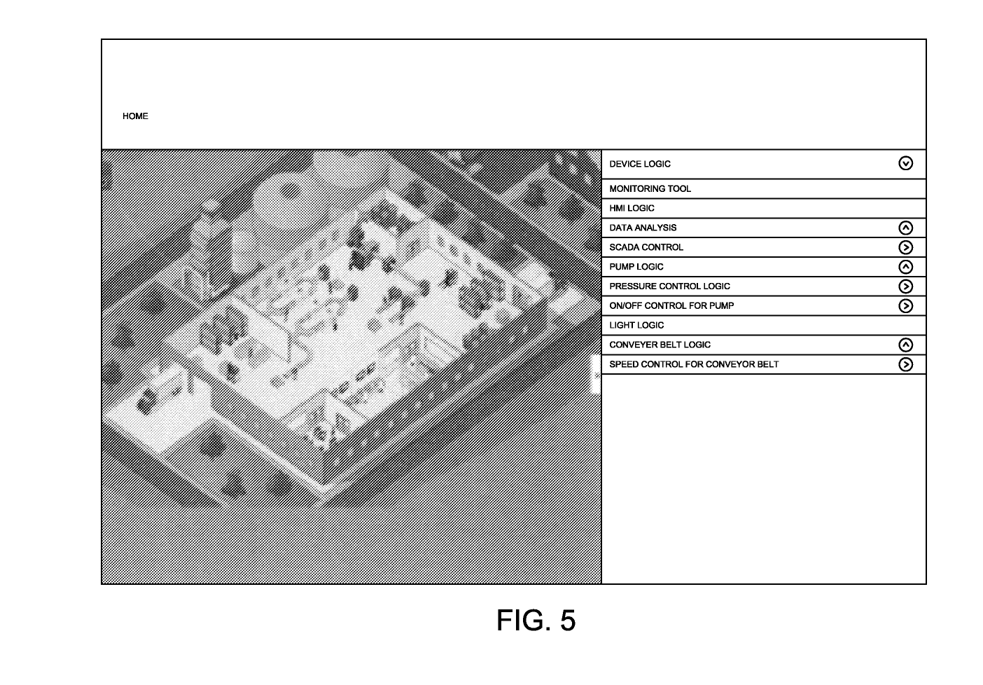

Referring now to FIGS. 4-8, examples of screenshots of graphic user interfaces illustrating the building and deployment of control logic are described. FIG. 4 shows a screen shot of different control logic solutions that can be purchased by a user. A user can select a particular package for purchase. FIG. 5 shows a geographical display showing a geographical layout of a plant with various pieces of control logic. A user can navigate this screen to select control logic for deployment, for monitoring, or for re-deployment to mention a few examples. A user can click on the screen to view successively narrower geographic views until they reach the area of interest, in one example.

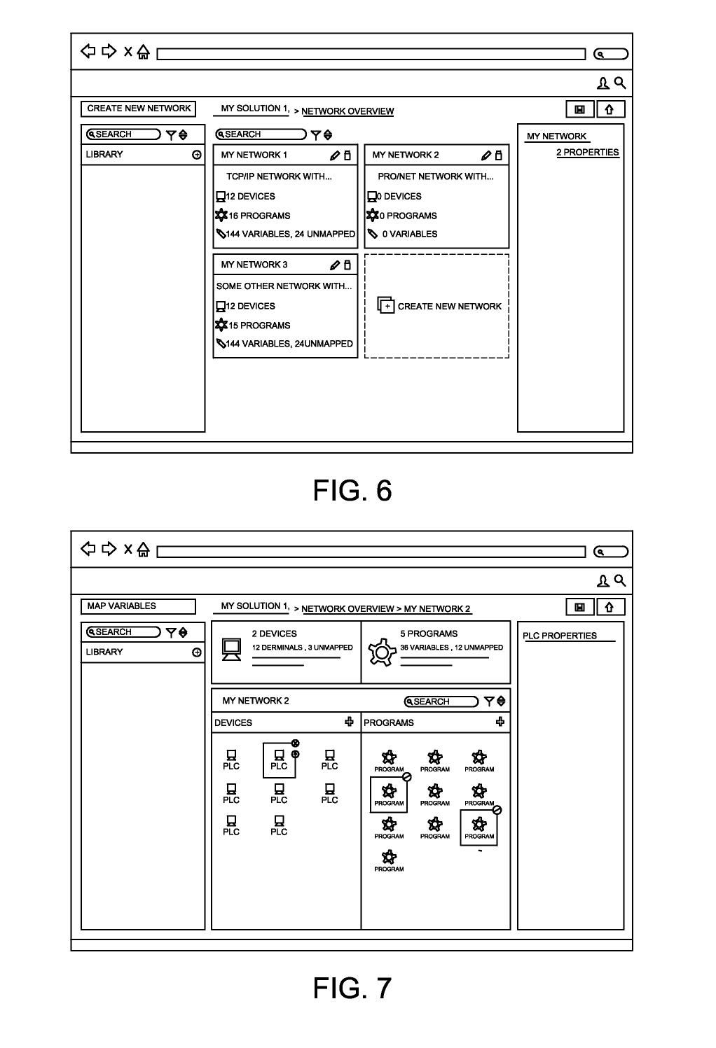

FIG. 6 shows a screen shot of a logical view of one element of control logic and interconnections of that control logic. FIG. 7 shows a screen shot of an expansion of the “my network 2” of FIG. 6 showing the devices and programs associated with “network 2.”

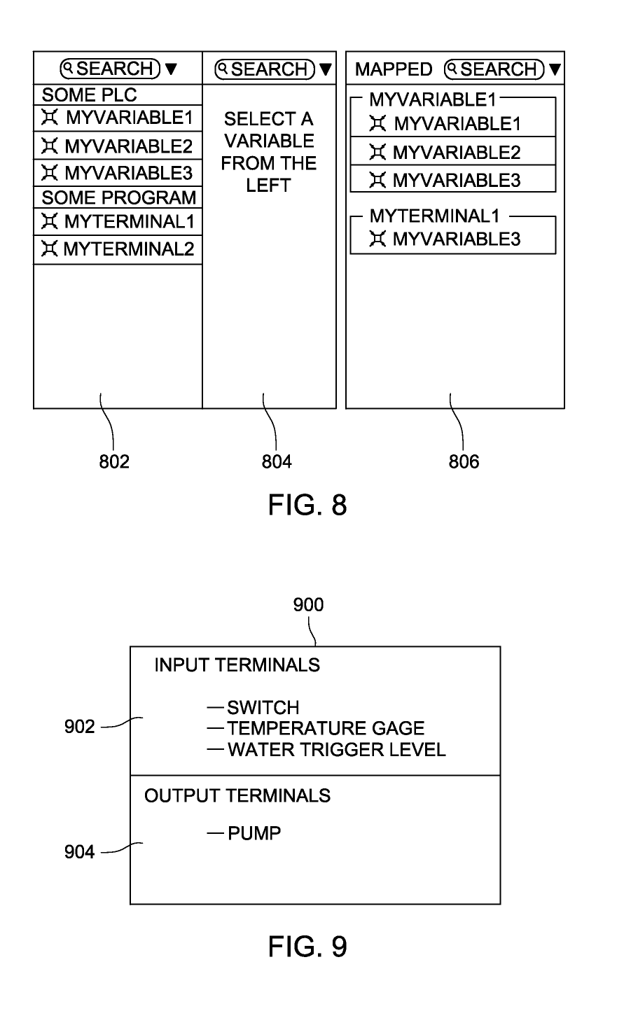

FIG. 8 shows a screen shot of the mapping process. The user first selects a variable from the left column 802, then the middle column 804 populates with eligible possible connections. Subsequently, the user clicks the second variable in the list on the middle column 804 to complete the connection. The mapped variables are grouped in the third column 806 by output. It will be understood that these figures illustrate only a few examples of possible screens that can exist and the exact configuration, features, and sizing used (to mention only a few aspects) can vary.

The present approaches allow customers to develop control logic and deploy it using a cloud-based (or communication network-based) system. Customers are able to either create the control logic themselves or purchase the control content (see, e.g., FIG. 4) and choose the components they would like to use in their solution. Such tools can include PLC logic tools, HMI logic tools, data analysis tools, monitoring tools, and simulation tools. Customers can also collaborate on developing control logic where one person may create, for instance, a pressure control, while another creates an on/off timer. In this way, different users can create different parts of the solution and then combine them to create a single solution. Once the different portions of logic are created or bought, the customer can place them using the present approaches, set the requirements of the logic, and determine how that logic will execute.

Libraries of control logic, which are typically logic blocks created for a specific task that can be deployed to different types of hardware, can also be created and sold within the marketplace so customers do not have to develop them. An example of one library might be a turn-on function for many different brands. Configuration templates can also be created and sold for a specific piece of hardware. One such template might be sprinkler pump for a particular brand or manufacturer that includes turning it on/off, setting pressure levels, speeds, and so forth.

Users can build control logic by associating different components together. Users can also configure logic, hardware and configurations independent of one another. The present approaches also determine which components can run together and users can associate different components through configurations. Users can view the library modules and simply drag and drop them on a GUI to assemble them into a piece (or pieces) of control logic.

Users can build control logic using different views of the same data. A geo-physical view will show the actual location of devices on a map (see, e.g., FIG. 5). A logical view will show the control logic that is executing. This logical view can be a list or an overlay on the existing geo-physical view (see FIG. 5). A network overview (see FIG. 6) can show which devices are interconnected. These different views can have multiple layers to group complex systems. For example, in subsets of the network view, users can expand the overview (see FIG. 7) or map logic variables to device input/output or to other logic variables (see FIG. 8).

Global variables may also be set in the approaches described herein. More specifically, variables that apply to multiple logical or physical components may be stored and used by these components. These variables can be set or modified by a user with a GUI.

Referring now to FIG. 9, one approach to mapping input/output variables is described. On a GUI 900, logical inputs and outputs are mapped to actual software device terminals. In other words, a particular input of the software control logic is associated with a particular physical input (from a physical device). For example, the inputs 902 of pump control logic may be set to be from a switch, a temperature gauge, and a water level trigger. The outputs 904 are set to be connected to a pump. Once mapped, the control logic can be deployed and then physically installed at the automation controller. For example, a technician may need to make appropriate wired connections between the inputs (the switch, temperature gauge, or water level trigger) and the device (e.g., a PLC) on which the actual control logic resides. This technician may also make connections from the device (e.g., PLC) on which the control logic resides to output destinations (e.g., a pump). At this point, physical installation of the control logic is complete.

Mapping also is provided between multiple automation controllers. For example, the output of one automation controller (e.g., a pump) is mapped to the input of a second automation controller (e.g., a drain processing device).

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A method of creating control logic at a communication network and integrating the control logic to a remotely located automation controller, the method comprising:
selecting an automation controller on which to deploy control logic;
at the communication network, building the control logic for deployment to the automation controller selected;
at the communication network, mapping the control logic to the hardware configuration of the automation controller selected; and
loading the control logic on to the automation controller that is selected and integrating the control logic to the selected automation controller.

2. The method of claim 1, wherein building the control logic utilizes at least one control logic module stored in a data storage device.

3. The method of claim 1, wherein building the control logic utilizes at least one control logic module created by a user at the communication network.

4. The method of claim 3, further comprising storing the at least one control logic module that is created by the user at the data storage device.

5. The method of claim 1, wherein building the control logic uses at least one control logic module that is stored at a data storage device and uses at least one control logic module created by a user at the communication network.

6. The method of claim 5, further comprising storing the at least one control logic module created by the user at the data storage device.

7. The method of claim 1 wherein the mapping comprises a mapping between control devices and generating communication protocols therebetween.

8. An apparatus for creating control logic at a communication network and integrating the control logic to a remotely located automation controller, the apparatus comprising:
a service interface having an input and an output, the interface configured to receive a selection from a user at the input of an automation controller on which to deploy control logic; and
a controller deployed at a communication network and coupled to the interface, the controller being configured to build the control logic for deployment to the automation controller selected, the controller being configured to map the control logic to the hardware configuration of the automation controller selected, the controller being configured to load the control logic on to the automation controller that is selected.

9. The apparatus of claim 8, wherein the control logic utilizes at least one control logic module stored in a data storage device.

10. The apparatus of claim 8, wherein the control logic utilizes at least one control logic module created by a user at the communication network.

11. The apparatus of claim 10, wherein the controller is configured to store the at least one control logic module that is created by the user at the data storage device.

12. The apparatus of claim 10, wherein the control logic uses at least one control logic module that is stored at a data storage device and uses at least one control logic module created by a user at the communication network.

13. The apparatus of claim 12, wherein the controller is configured to store the at least one control logic module created by the user at the data storage device.
